(19) United States
(12) Patent Application Publication
(10) Pub. No.: US 2007/0106598 A1
(43) Pub. Date: May 10, 2007

(54) Methods and apparatus for providing mortgage insurance with appraisal reimbursement

(75) Inventors: Christopher W. Schollaert, Cary, NC (US); Timothy R. Kirian, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 11/255,507

(22) Filed: Oct. 21, 2005

(51) Int. Cl. G06Q 40/00

(52) U.S. Cl. 705/38

(57) ABSTRACT

Systems and techniques for combined insurance packages to address consumer concerns that mortgage insurance is difficult to cancel are described. A system and method according to one aspect of the present invention receives notification that a mortgage insurance policy is to be canceled, automatically inquires if a customer has obtained an appraisal as part of the cancellation process, and provides for customer reimbursement up to a predetermined limit where it has been. Such appraisal reimbursement may be combined with any appropriate type of mortgage insurance, and may be marketed in conjunction with the marketing and insurance packages including a combination of mortgage insurance and one or more other insurance components.

### FIELD OF THE INVENTION

The present invention relates generally to systems and techniques for marketing and providing financial service products. More particularly, the invention relates to systems and techniques for providing mortgage insurance having an appraisal reimbursement feature whereby customers are reimbursed for the cost of an appraisal used to cancel their mortgage insurance.

### BACKGROUND OF THE INVENTION

The purchase or financing of a home by a consumer is a substantial transaction. Consumers often take a mortgage to finance a portion of the purchase price of the home. The mortgage loan is typically quite large and is expected to be repaid over a period that may extend for many years. A continuing risk of borrower default is present during the repayment period. In addition, a default and foreclosure is a costly event for the mortgage holder, typically involving some months of missed interest payments, fees, possible depreciation of the property securing the mortgage, and sale expenses. Lenders require some protection against the costs of default. Such protection may come in the form of a significant down payment by the borrower. Where the down payment is at least 20% of the value of the property, the lender does not finance more than 8.0% of the value of the property and experience has shown that this “equity cushion” is usually sufficient to cover expenses associated with default and foreclosure. In such a case, the loan to value ratio (“LTV”) is 80%.

However, many borrowers wish to finance a larger proportion of the value of the property. Traditionally, lenders who finance more than 80% of the value of a property require a borrower to pay for private mortgage insurance in order to protect the lender. Such insurance is typically necessary in order to sell a mortgage loan to investors if the loan exceeds 80% of the value of the property. Private mortgage insurance covers the shortfall in the value of the property below the amount owed in the event of default and foreclosure.

Consumers often do not attach a high value to private mortgage insurance and seek to avoid having to pay for it. Mortgage insurance protects the mortgage holder, not the consumer, and consumers often do not see how they benefit by paying for insurance to protect another party. Accordingly, consumers are receptive to arrangements that allow them to avoid paying for mortgage insurance. One such arrangement, which has proven highly popular, is a financing arrangement under which the borrower receives a first mortgage loan for 80% of the value of the property and a second mortgage loan for 10% of the value of the property. The borrower contributes the remaining 10% of the purchase price in cash. Under such an arrangement, the holder of the first mortgage finances 80% of the purchase price, and therefore does not need to be protected by mortgage insurance.

One disadvantage of financing using simultaneous first and second mortgage arrangements is that such arrangements are typically available only to borrowers with exceptionally good credit ratings, often manifested by a FAIR ISAAC AND COMPANY (FICO) score of 720-850. A borrower with such a credit rating is likely to consider alternatives to mortgage insurance, while a borrower with a lower credit rating may accept mortgage insurance with reluctance.

Toward the end of overcoming such borrower reluctance, a number of mortgage insurance products are marketed in which the mortgage insurance premium is split between a portion paid at closing and a portion paid on a monthly basis. When the LTV decreases from 95% or 90% to 80% or below, the borrower may be allowed to terminate the mortgage insurance. Lenders and mortgage servicers have specific requirements that must be satisfied before a borrower may cancel mortgage insurance. These requirements often comprise the passage of two or more years since the date of the loan origination, evidence of the home's value showing borrower equity over 20%, and a good payment history. The LTV can drop for a number of reasons. First, the consumer can regularly pay the mortgage payments until the equity in the home has built up above 20%. Second, a consumer may make a lump sum payment of principle thereby increasing the consumer's equity in the house and decreasing the principle owed on the loan. Third, the value of the home can substantially appreciate. Some combination of the above exemplary LTV reducing events may occur.

Where the LTV is reduced due to home appreciation, it is typical for a lender or investor to require that the home owner obtain an appraisal to establish the new higher value of the home. Such an appraisal can cost several hundred dollars, and this cost may be cited as yet another reason why consumers are reluctant to purchase mortgage insurance. From a consumer's perspective, even if the consumer's house appreciates in value so that mortgage insurance is no longer required, the consumer is obligated to pay an appraisal fee of several hundred dollars out of pocket which may only be recouped over many months, or in the alternative may simply keep paying the mortgage insurance. Warranted or not, one negative perception of mortgage insurance is that it is difficult to cancel.

### SUMMARY OF THE INVENTION

Among its several aspects, the present invention recognizes that it is important to remove such sources of possible frustration and address consumers' concerns about mortgage insurance cancellability by providing customers with the assurance that they can cancel their mortgage insurance in the future at no net cost to themselves. One aspect of the present invention comprises a method of reimbursing a customer for an appraisal performed to support a termination of mortgage insurance. The process may suitably comprise the steps of receiving an indication that a mortgage insurance policy is to be terminated as a result of a drop in LTV, automatically contacting the customer previously responsible for the mortgage insurance premium payments to determine if the LTV drop was the result of an appraisal obtained by the customer. If it was, the customer is reimbursed for the cost of the appraisal up to a predetermined value.

An alternative aspect of the present invention provides a system of reimbursing a customer for an appraisal performed to support cancellation of mortgage insurance comprising means for receiving an indication that a mortgage insurance policy is to be canceled as a result of drop in LTV ratio, and means for automatically contacting the customer to determine if an appraisal was obtained by the customer as part of the cancellation. Upon validation of the purpose and cost of the appraisal, the customer is reimbursed up to a predetermined value.

A more complete understanding of the invention, as well as further features and advantages of the invention, will be apparent from the following Detailed Description and from the claims that follow below.

### BRIEF DESCRIPTION OF THE DRAWINGS

FIG. 1 illustrates a system for providing mortgage insurance with an appraisal reimbursement feature according to an aspect of the present invention;

FIG. 2 illustrates additional details of selected components of the system of FIG. 1;

FIG. 3 illustrates an exemplary form used to enter coverage parameters;

FIG. 4 illustrates an exemplary display used to present coverage details and costs in response to submission of a set of coverage parameters;

FIG. 5 illustrates an exemplary display used to present a summary of coverage parameters in order to allow commitment to a coverage package;

FIG. 6 illustrates a process of providing mortgage insurance with an appraisal reimbursement feature according to an aspect of the present invention;

FIG. 7 illustrates details of an appraisal reimbursement process in accordance with an aspect of the present invention;

FIG. 8 illustrates an exemplary appraisal reimbursement reminder letter;

FIG. 9 illustrates details of generating an appraisal reimbursement welcome message as part of an alternative reimbursement process in accordance with an aspect of the present invention;

FIGS. 10A and 10B illustrate details of the alternative reimbursement process; and

FIG. 11 illustrates details of an exemplary process of handling returned mail as part of the alternative reimbursement process.

### DETAILED DESCRIPTION

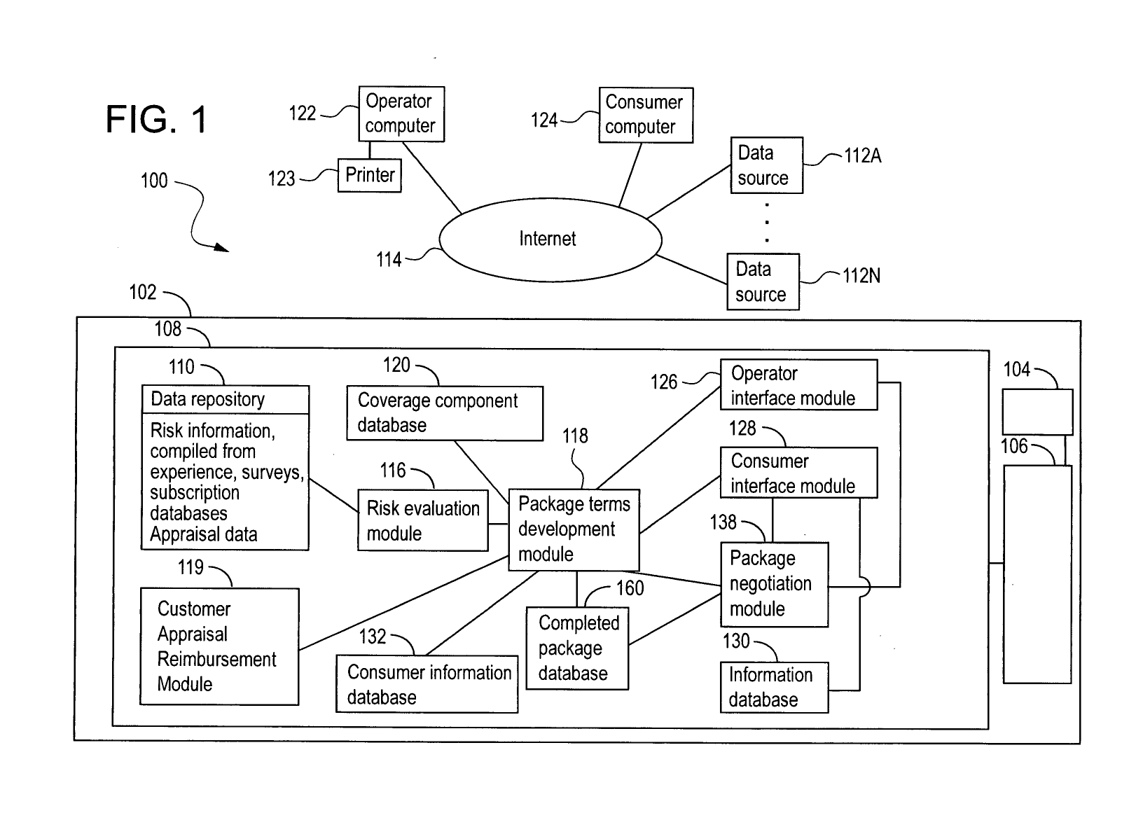

FIG. 1 illustrates a system 100 for providing mortgage insurance with an appraisal reimbursement feature according to an aspect of the present invention. The system 100 preferably comprises a server 102, including a programmed processor 104, memory 106 and long term storage 108. The server 102 suitably hosts various data repositories and databases preferably implemented as data files hosted in the long term storage 108, and modules, preferably stored in the long term storage 108 and executed under the control of the processor 104. The server 102 preferably hosts a data repository 110 including collected statistical information relating to risks involved in providing insurance products. For mortgage insurance products, the risks typically include the risk that a borrower will default on a mortgage loan and that a loss will be incurred as a result of such default.

The risk of loss related to mortgage insurance depends on the risk that default will occur and, if default does occur, that a sale of the property will realize less than the amount owing on the mortgage. For job loss insurance, the risk may depend on the amount and number of payments that may be made as a result of involuntary unemployment of the covered party. Analysis of such risks involves estimating the probability and duration of job loss, taking into account the size and frequency of payments that are to be made and the maximum number of payments to be made. For example, a job loss insurance policy may specify that a borrower's mortgage payment will be made for up to six months in the event that the borrower becomes involuntarily unemployed during the first two years of the loan. The risks related to such insurance depend on factors such as the likelihood that the borrower will become unemployed, the amount of each payment to be made, and the expected duration of unemployment.

Statistical information for use by server 102 may be gathered using a plurality of data collection sources 112. such as the sources 112A . . . 112N. There may be any suitable number of data collection sources 112. The sources 112A . . . 112N may furnish the information to the server 102 through a publicly accessible network 114, such as the Internet. The data collection sources 112A . . . 112N suitably provide periodically updated data related to risks being insured against, costs of appraisal by region, statistics on customers seeking appraisal reimbursement or the like. Such data may include loss experience, industry reports and the like, and the data collection sources 112A . . . 112N may take any of a number of forms, such as computer workstations operated by data entry operators, connection points for the reception of subscription data or the like. Once the information is gathered and stored, it may be processed by a risk evaluation module 116, in order to determine the risk of events of interest, in order to design and price insurance products to provide protection against such risks. The risk evaluation module 116 receives information describing the particular risks to be insured against, and evaluates the risks using the received information as well as information extracted from the repository 110.

The risk evaluation module 116 is particularly useful in assembling packages of coverage. In some cases, protection provided by insurance against a particular risk may mitigate a related risk, and allow discounted pricing or added value for a package insuring such related risks together. For example, the risk evaluation module 116 may suitably be used to evaluate a combined package including a mortgage insurance component with a job loss insurance component and appraisal reimbursement. The job loss insurance component may be activated upon involuntary termination of the employment of a covered party, and make the covered party's mortgage payment during such unemployment, up to a specified maximum number of payments. The mortgage insurance component insures the party servicing the mortgage against default by the borrower. The appraisal reimbursement reimburses a customer who pays for an appraisal used in canceling mortgage insurance.

The risk evaluation module 116 may suitably be used to weigh the overall costs involved in providing the package. The risk evaluation module 116 may also be used to evaluate actual or proposed changes in the various package components to determine the effects of the changes on the overall risk, and therefore cost, of providing the insurance components of the package. Such weighing of risks can provide important information that can be used to price and design services. For example, providing job loss insurance carries a cost based on the analysis of the risks. If the job loss insurance makes mortgage payments for the borrower during the borrower's unemployment, the cost of providing the insurance can be expected to increase as the maximum number of payments that can be made is increased. On the other hand, the fact that mortgage payments will be made during periods of unemployment decreases the risk of default. As the maximum number of payments that can be received under the job loss component increases, and especially as the number of payments that can be received during a single period of unemployment increases, the risk of providing the mortgage insurance component of the package decreases. These risks, and their costs, can be evaluated and balanced by the risk evaluation module 116 and the optimum terms for each component of the package can be chosen. The server 102 may also host a package terms development module 118, used to assemble a package including various components. Details of the coverage components may be stored in a coverage components database 120. The package terms development module 118 may accept specified criteria as inputs and use data provided by the risk evaluation module 116 to design package terms meeting the specified criteria.

One exemplary criterion is competitiveness with other products. A provider of a package including mortgage insurance can be expected to want to price the product so that it will be competitive with other mortgage insurance products. The package terms development module 118 may be designed to allow a product designer to specify a desired price, for example, and then to develop a set of terms that can be offered at the specified price. This approach to development of terms may suitably include evaluating the cost of each component using the risk evaluation module 116. Evaluation is performed by submitting component terms to the module 116, receiving risk and cost information relating to those terms and progressively adjusting the terms of the package components, either singly or in combination until a package meeting the specified criteria is developed. If no package can be developed meeting the specified criteria, the module 118 may return information describing criteria that can be met.

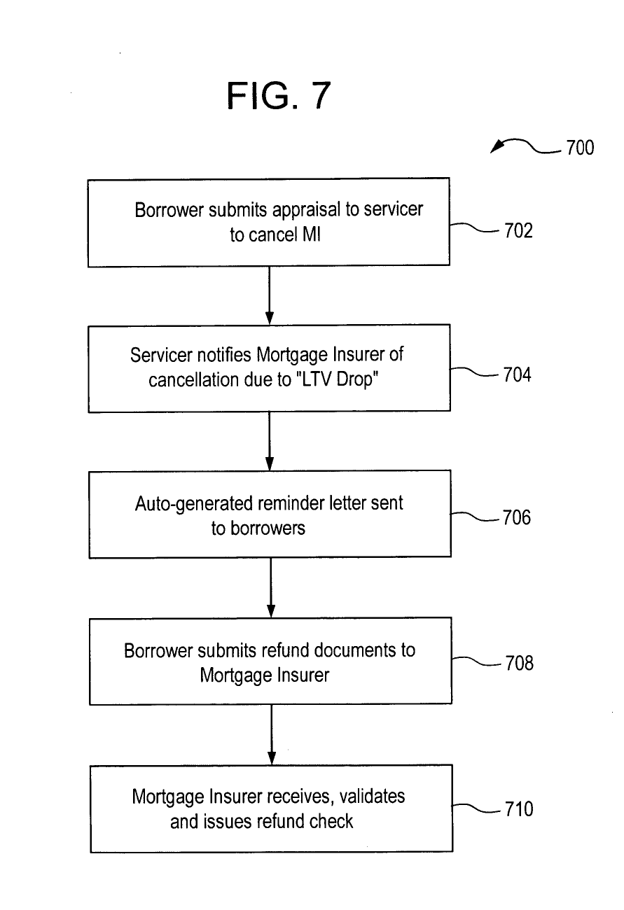

In accordance with the present invention, the long term storage 108 further includes a customer appraisal reimbursement module 119 which is utilized in conjunction with the package terms development module 118 to provide mortgage insurance with appraisal reimbursement. As further described below in connection with the discussion of FIGS. 7-11, the customer appraisal reimbursement module supports the reimbursement of customers for the costs of an appraisal used in canceling mortgage insurance up to a predetermined limit. The predetermined limit may be a single nationally applied limit, such as $500, or different limits may be stored by region so that different costs apply in more expensive regions than in less expensive regions. If desired, appraisal reimbursement data may be obtained and stored in data repository 110, or stored in a separate appraisal reimbursement data depository, and accessed by the customer appraisal reimbursement module. For example, appraisal cost data can be collected and stored by region for use in evaluating what rate of reimbursement should be provided. As a further example, rate data for the rate at which consumers take advantage of appraisal reimbursement by region or over a predetermined period, such as two years, five years, or the like may be collected and stored for use in evaluating how to price the appraisal reimbursement part of the package, what portion of the appraisal to reimburse, or the like.

According to one aspect of the invention, a detailed description of the reimbursement package is provided to a borrower as part of the closing documents. After the loan closes, an appraisal reimbursement notice is sent to the borrower by the mortgage insurer. If the property appreciates sufficiently, the borrower may initiate mortgage insurance cancellation. To this end, the borrower obtains an appraisal and submits it to the loan servicer. In doing so, the borrower must comply with the applicable mortgage insurance cancellation and appraisal acceptance policies. Where appropriate, the loan servicer notifies the mortgage insurer of cancellation.

For example, the Mortgage Industry Standards Maintenance Organization (MISMO) has promulgated standard cancellation codes for notification of mortgage insurers of mortgage insurance cancellation as follows: code 1 (payoff) indicates cancellation as a result of a mortgage being paid in full, code 2 (LTV drop) indicates cancellation as a result of LTV drop, and code 5 (other) is a catchall category for cancellations as a result of other reasons. Codes 3 and 4 are reserved and not presently used. Thus, a mortgage servicer may notify the mortgage insurer that the mortgage insurance for a particular borrower for an identified mortgage should be cancelled for codes 1, 2 or 5. This information may be provided by letter, fax, email, electronic data interface (EDI) or the like. By way of example, a mortgage servicer may use a first operator computer 122 to send the above information to a second operator computer 122 at the mortgage insurer. The second operator computer 122 may be suitably programmed to automatically recognize codes 2 and 5 as codes for which appraisal reimbursement may be applicable. For code 1, appraisal reimbursement is recognized as not applicable.

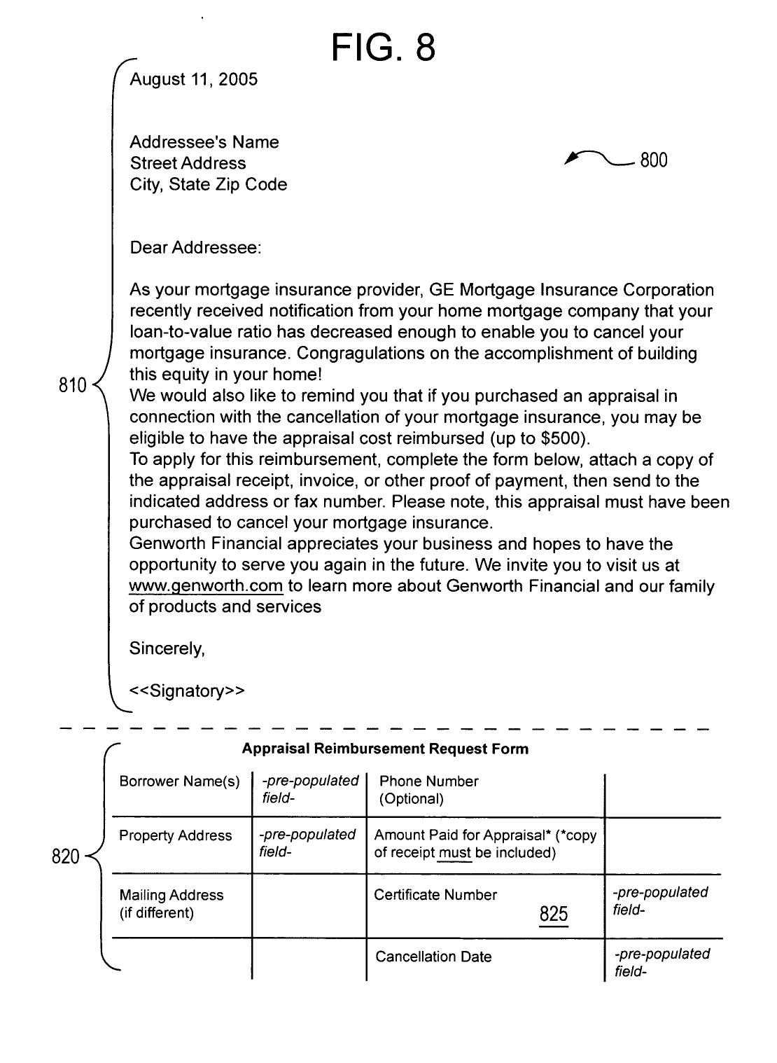

Upon recognition of one of the codes 2 or 5, a letter may be automatically generated including a reimbursement application for use by the borrower if appropriate. One example of such a letter is shown in FIG. 8 and discussed below. The letter including the reimbursement application is sent to the borrower. The borrower submits this application and proof of the cost of the appraisal, and the mortgage insurer validates the application and issues appraisal cost reimbursement to the borrower.

The system 100 may suitably be accessible to operators using computers such as the operator computer 122, allowing the operator to develop packages by submitting desired criteria and receiving descriptions and cost information for packages meeting the desired criteria. Operators may suitably include employees of a mortgage insurance company, developing packages for marketing to consumers. In addition, employees of a lender having a business relationship with an insurance package provider may be given operator access in order to develop packages for the lender.

It may also be desired to offer consumers direct access to product information. Consumers, such as prospective borrowers, may be allowed to review information relating to products generally available and priced according to standard criteria. For example, a package may provide six months of job loss protection in combination with mortgage insurance and appraisal reimbursement, and may be priced based on the loan amount and the loan to value ratio of an insured mortgage. In addition, it may be desired to offer products designed based on individualized criteria furnished by consumers. Therefore, the system 100 may be accessible to consumer operated computers, such as a consumer computer 124, in order to allow a consumer to obtain product information and to provide individualized information.

Both the computers 122 and 124 may suitably gain access to the server 102 through the Internet 114, with appropriate security and authentication measures being taken in order to distinguish between classes of users of the system 100. For example, it is highly desirable to distinguish an internal operator using the computer 122 from a consumer using the computer 124, because the operator can be allowed much greater access to system features than can a typical consumer. Suitably, the system 100 includes an operator interface module 126 and a consumer interface module 128. The operator interface module 126 is preferably designed to offer a more efficient interface to an experienced user and to offer greater flexibility of operation. For example, the module 126 may allow an operator to construct packages to be offered for sale and to design displays and discussions about these packages. By way of example, an employee of a mortgage insurer using operator computer 122 may access the system through operator module 126 to generate descriptive material to describe the conditions upon which appraisal reimbursement is available, the amount of reimbursement available, answers to frequently asked questions, or the like.

The consumer interface module 128 preferably includes an easy to use interface adapted so it may be used by a relatively inexperienced user. Interface module 128 allows access that is restricted to a controlled set of information that is relevant to the consumer's specific needs or is of a general educational and promotional nature. The consumer interface module 128 preferably allows access to educational and promotional information that may be extracted from an information database 130 by the module 128 for presentation to the consumer. The educational and promotional information may include general descriptions of various kinds of insurance and their value. The educational and promotional information may also include descriptions of various products and packages that are available.

The consumer interface module 128 may allow the consumer to submit information describing the consumer's needs. The consumer interface module 128 may suitably provide the consumer with forms allowing submission of information describing the consumer's needs. The consumer interface module 128 submits the information to the package terms development module 118. The package terms development module retrieves appropriate products from appropriate modules, such as the risk evaluation module and the customer appraisal reimbursement module 119, and the component database 120. It then assembles a package and transfers information relating to the package to the consumer interface module 128 for presentation to the consumer.

Preferably, any identifiable information provided by a consumer is protected using suitable security techniques, such as public key encryption. The consumer interface module 128 suitably receives information using information entry forms presented as hypertext pages. For example, in the case of mortgage insurance, a form might require information such as desired loan amount, property value, property address and the like, as well as, general selections for the type of insurance package desired. This information may be stored in a consumer information database 132 for retrieval and use in developing insurance packages based on requirements submitted by the consumer and for storing package information relating to a consumer.

Once the package has been designed, and the risk and cost information for the package determined, the consumer interface module 128 may compute a price for the package and pass it to the consumer computer 124, preferably by constructing a hypertext page presenting the information and passing it to the computer 124 for display. Package details may also be stored in the consumer information database 130. Price computation may suitably be based on standard factors applicable to all consumers, such as the amount of the loan, the loan to value ratio and the particular product desired. If desired, however, the system 100 may be programmed or designed so that individual risk calculations are performed for individualized consumer information. If that is the case, the consumer interface module 128 may be used to submit information provided by the consumer to the package terms development module 118, which invokes the risk evaluation module 116 to determine risk and cost information and develop suitable package terms and pricing.

If desired, a consumer may be permitted to commit to coverage once the coverage details have been examined. In that case, the consumer may indicate a desire to commit to a coverage package and the coverage details may be assembled by a package negotiation module 138. The coverage details may suitably be stored in a consumer information database 132 and a completed package database 160.

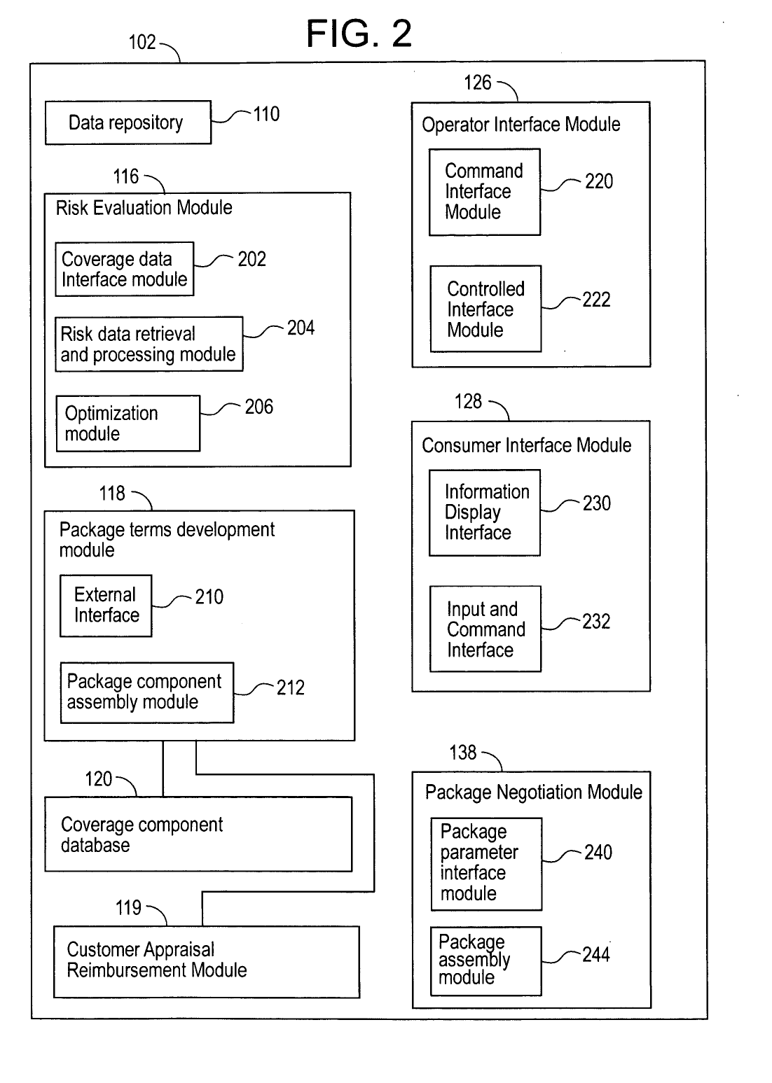

FIG. 2 illustrates additional details of the server 102, showing additional details of the risk evaluation module 116, the package terms development module 118 and customer appraisal reimbursement module 119, the operator interface module 126, the consumer interface module 128 and the package negotiation module 138. The risk evaluation module 116 suitably includes a coverage data interface module 202, allowing the submission of data such as a set of coverage requirements. The risk evaluation module 116 further includes a risk data retrieval and processing module 204, allowing extraction of data from the repository 110 in response to inputs received by the coverage data interface module 202 and processing of the information in order to compute risk information for a particular aspect of coverage, for example. The data retrieval and processing module 204 is able to compute risk information for each aspect of coverage in a package.

For example, the coverage requirements may include providing mortgage insurance for a loan of $200,000 at 6.0% and including a job loss protection policy covering up to a maximum of six months of payments during a period of unemployment of a borrower occurring within the first two years after closing. If the monthly payment for such a loan is approximately $1200, then the maximum payment under the job loss protection component of the package would be $7200. The data retrieval and processing module 204 computes the cost of the mortgage insurance component and the job loss component by taking the possible payments and factoring in the risk that the payments will need to be made. In the case of the job loss component of the policy, the maximum payout of $7200 would be relatively unlikely because it would require a full six months of unemployment. Smaller payouts would be more likely, and the module 204 suitably uses data from the repository 110 to evaluate the costs of coverage, taking into account the potential payouts and their probability.

In addition, the presence of the job loss component of the package affects the likelihood of payment under the mortgage insurance policy. The risk data retrieval and processing module 204 computes the cost of the mortgage insurance and then discounts this cost by taking into account the reduced likelihood of default on the mortgage due to the job loss component of the package. This discounted cost of the mortgage insurance component is combined with the calculated cost of the job loss component to determine the overall cost of the package.

The cost information is then submitted to an optimization module 206. The optimization module 206 evaluates the various aspects of a package and then makes modifications to various parameters of the aspects of the package and examines the effects of the modifications on the overall cost of the package. Such modification and examination can result in improvements to the package at no cost or a relatively small cost, or can even result in a combination of increased protection at a lower overall cost of the package.

To continue the previous example, the optimization module might examine the effects of extending the maximum number of payments under the job loss component from six to seven. Analysis of this extension would be accomplished by increasing the potential number of payments to seven and submitting this increased number to the risk data retrieval and processing module.

The optimization module 206 continues to make and evaluate adjustments according to a predetermined arrangement. For example, adjustments may be made so as to minimize overall costs, adjustments may be made so as to achieve the maximum number of payments possible under the job loss component of the package without increasing overall package costs, or adjustments may be made so as to achieve the maximum number of payments possible under the job loss component of the package while staying within a specified cost constraint. The optimization module 206 then returns information describing the overall cost of providing the package, the cost associated with each package component and the parameters of each package component once optimization has been accomplished.

The package terms development module 118 includes an external interface 210 and a package component assembly module 212. The external interface 210 receives inputs such as descriptions of desired features of a coverage package. The desired features may suitably include desired areas of coverage, overall package pricing and the like. The package component assembly module 212 retrieves coverage components from the database 120 and submits the coverage criteria and the coverage components to the risk evaluation module 116. The package component assembly module 212 then receives optimized package terms from the risk evaluation module 116 and returns the package terms using the external interface module 210.

The operator interface module 126 includes a command interface module 220 and a controlled interface module 222. The command interface module 220 allows direct access to various elements of the server 102. For example, the command interface module 220 allows the operator to examine the coverage component database 120 directly and to submit various coverage components and criteria to the risk evaluation module 106 in order to assemble a package. The controlled interface module 222 allows operation in a prescribed way using forms assembled from a form database 224, and with information presented to the operator by the assembly and presentation of forms and displays.

The consumer interface module 128 includes an information display interface 230, providing access to educational and promotional information. The information display interface 230 allows access by the consumer to the information database 130, suitably through a sequence of hypertext pages with links to appropriate information in the information database 230. The consumer interface module 128 also includes an information and command entry interface 232. The information and command entry interface 232 provides a relatively tightly controlled mechanism for the consumer to provide information to the system 100 and to issue commands in order to receive specific coverage package information and, in appropriate circumstances, to select coverage for a specific requirement. The information and command entry interface 232 preferably operates through the presentation of forms to the consumer for data entry and submission of selections and commands and through the presentation of forms and displays for presentation of information to the consumer.

The package negotiation module 138 includes a package parameter interface module 240, for receiving information describing components required in a package. This information may suitably come from the operator interface module 126 or the consumer interface module 128 or the customer appraisal reimbursement module. Where customer appraisal reimbursement is selected as part of the package, customer appraisal reimbursement module 119 provides suitable details, such as borrower notifications, predetermined maximum appraisal reimbursement amounts, and the like. While it is presently preferred that this feature be offered at no charge to the borrower to allay borrower concerns regarding the difficulty of cancellation of mortgage insurance, it will be recognized that this feature could also be offered as an option to be paid for by the borrower. Additionally, once the customer has purchased a product with appraisal reimbursement, he or she might further use the consumer interface module 119 to review lender policies governing mortgage insurance cancellation, to obtain a list of certified appraisers stored in data repository 110, to review the terms of the appraisal reimbursement feature, or the like.

The package negotiation module 138 further includes a package assembly module 244, for assembling various components selected by an operator or consumer. For example, the parties to a set of package components may be a consumer and a package provider.

Once commitments for a package have been negotiated, the package negotiation module 138 suitably stores commitment information in the completed package database 160 of FIG. 1. Suitably, the database 160 includes a record for each package for which a coverage agreement has been negotiated. The record for a package suitably includes details of each coverage component of the package, the effective coverage date for the package, the cost information for each component and for the package as a whole, the date and time at which commitment occurred and the identities of the parties to the package.

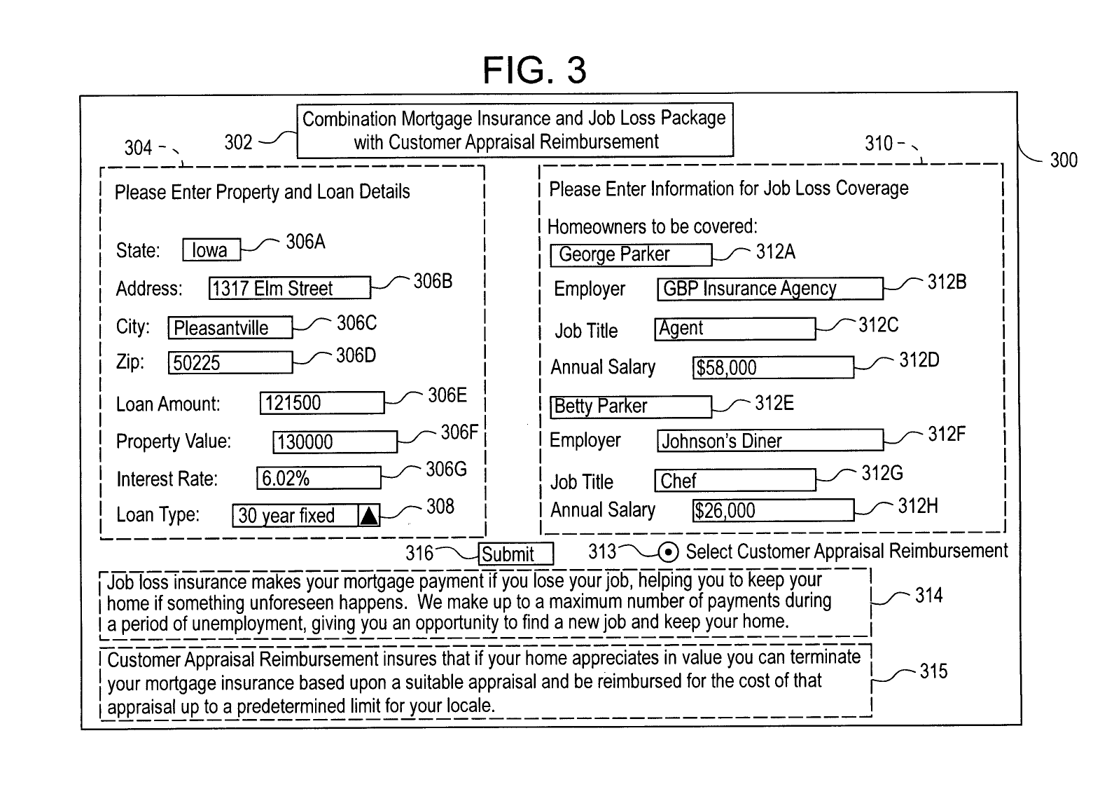

FIG. 3 illustrates a form 300, allowing submission of information to the system 100 in order to allow risk and cost assessment for a specific set of circumstances and return of information describing available coverage for the specified set of circumstances. The form 300 may suitably be presented by the operator interface 126 or the consumer interface 128, and may take the form of a hypertext page for display using a browser hosted on a computer such as the operator computer 122 or the consumer computer 124 of FIG. 1. The form 300 includes a caption 302, a property and loan information entry area 304, including fields 306A-306D for property address information, fields 306E-306G for loan information and a scrolldown list 308 for the loan type. The loan type is typically one of a relatively small number of available loan types, including fixed and adjustable loans having various parameters, so that a scrolldown menu is appropriate for entering this information.

The form 300 also includes a job loss information entry area 310, including fields 312A-312D and 312E-312H for entry of information about homeowners to whom the job loss protection is to apply, and a selection button 313 to select customer appraisal reimbursement information or to select a package including such reimbursement. The form 300 further includes exemplary information areas 314 and 315, and a “submit” button 316. A user enters the requested information in the appropriate fields and clicks the “submit” button to pass the information to the package terms development module 218. The sample information supplied in fields 306A-G, 308, 312A-H, 314 and 315 is provided as an example of a submission screen for a computer based system for applying for mortgage insurance with appraisal reimbursement, and should not be deemed to limit the scope of the subject invention.

This submission may suitably be accomplished by electronically transmitting the information to the consumer information database 132 of FIG. 1, where the information is accessible to the package terms development module 118. The package terms development module 118 retrieves the submitted information from the database 132, develops general parameters for the package to provide the coverage required in light of the information and invokes the risk evaluation module 116 to assess the risk and cost of the required coverage and to adjust the parameters for risk and cost optimization. The risk and cost of the coverage are computed through analyzing the costs and likelihood of default on the mortgage and the likelihood and cost of payment under the job loss protection component of the coverage, taking into account the fact that the job loss protection lowers the risk of default.

Adjustments to various parameters of the package are tested to determine their effect on the overall cost.

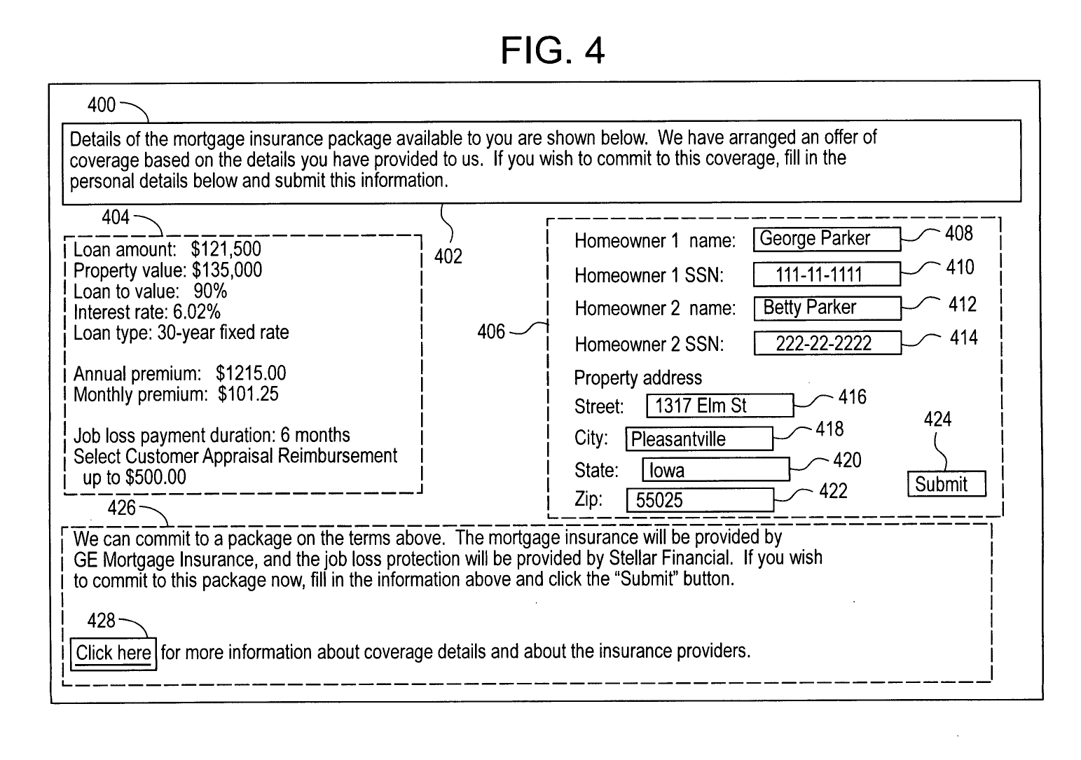

FIG. 4 illustrates a display 400, generated after a set of terms for a coverage package has been generated by the package terms development module 118, as a result of processing the information provided in form 300 of FIG. 3. The display 400 may suitably be presented in the form of a hypertext page for display by a hypertext browser hosted on a computer such as the computer 122 or 124. The display 400 includes a caption 402, a mortgage insurance coverage section 404, a job loss information entry section 406 including information entry fields 408-422, and a “Submit” button 424. The mortgage insurance coverage section 404 displays previously stored information submitted by a consumer or otherwise submitted in relation to a transaction. This information includes property address and mortgage information. The mortgage insurance coverage section further displays coverage information computed by the package terms development module 118. Here, this information is the annual and monthly premium for the coverage package, as well as the maximum number of payments that will be made in the event of job loss. In addition, the maximum amount of appraisal reimbursement is shown for the market that the customer is in. In the example, shown in FIG. 4, the customer will be reimbursed up to $500 for an appraisal used in canceling the mortgage insurance.

The display 400 can also be used to enter into a commitment for coverage on the terms described. Thus, the job loss information entry section 406 includes information entry block 408-422 for entry of information not previously submitted, and a “Submit” button 424 to submit the information and indicate a desire to commit to coverage as described in the section 404. The information section 426 includes additional details, such as the identities of the parties providing the coverage components, together with a link 428 allowing the display or printing of further information. For example, further details of appraisal reimbursement can be obtained by clicking on the link 428.

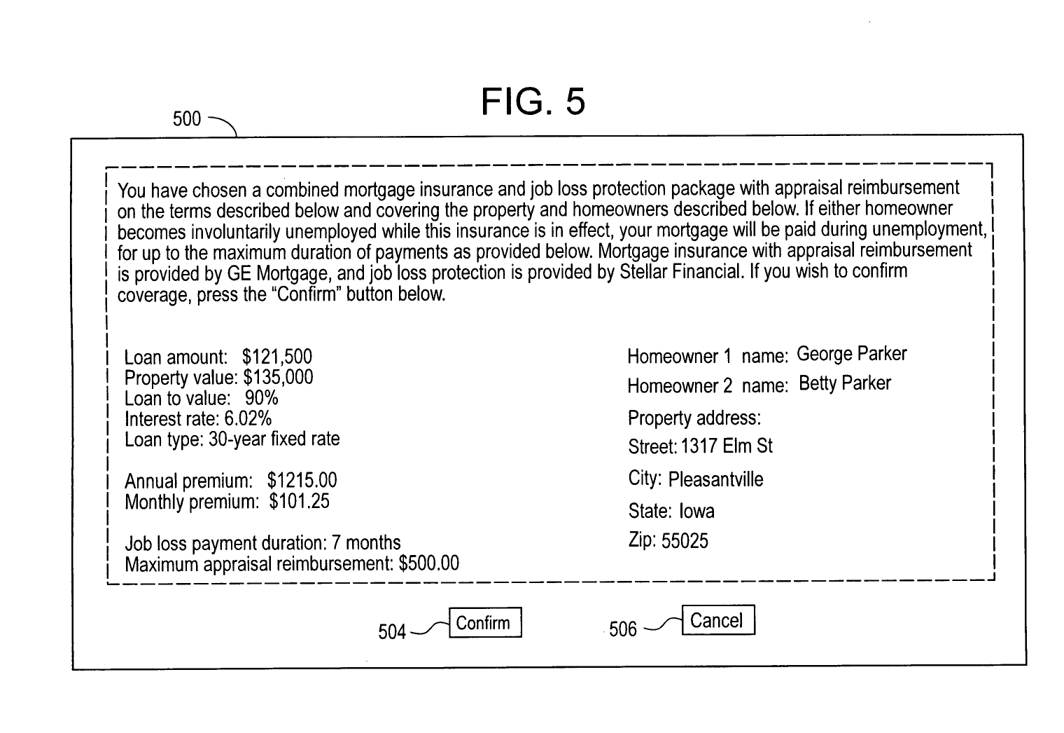

FIG. 5 illustrates an exemplary display 500, presented after activation of the “Submit” button 424 of FIG. 4. The display 500 includes a coverage description area 502, presenting details about the proposed coverage package, in order to give a user an opportunity to review the package before entering into a commitment. The display 500 also includes a “Confirm” button 504 and a “Cancel” button 506. If the user activates the “Cancel” button, no commitment information is submitted and a suitable display is presented indicating that no coverage package has been entered into. If the “Confirm” button 504 is activated, commitment information is stored in the database 132 of FIG. 1 and the completed package database 160 of FIG. 1 and relayed to responsible parties for action. For example, a set of documents may be prepared for inclusion in a loan package being prepared in connection with the insurance package. This set of documents would describe the mortgage insurance package including appraisal reimbursement, identify the provider, and address the features of the appraisal reimbursement component of the package, such as the maximum appraisal reimbursement of $500 shown in FIG. 5.

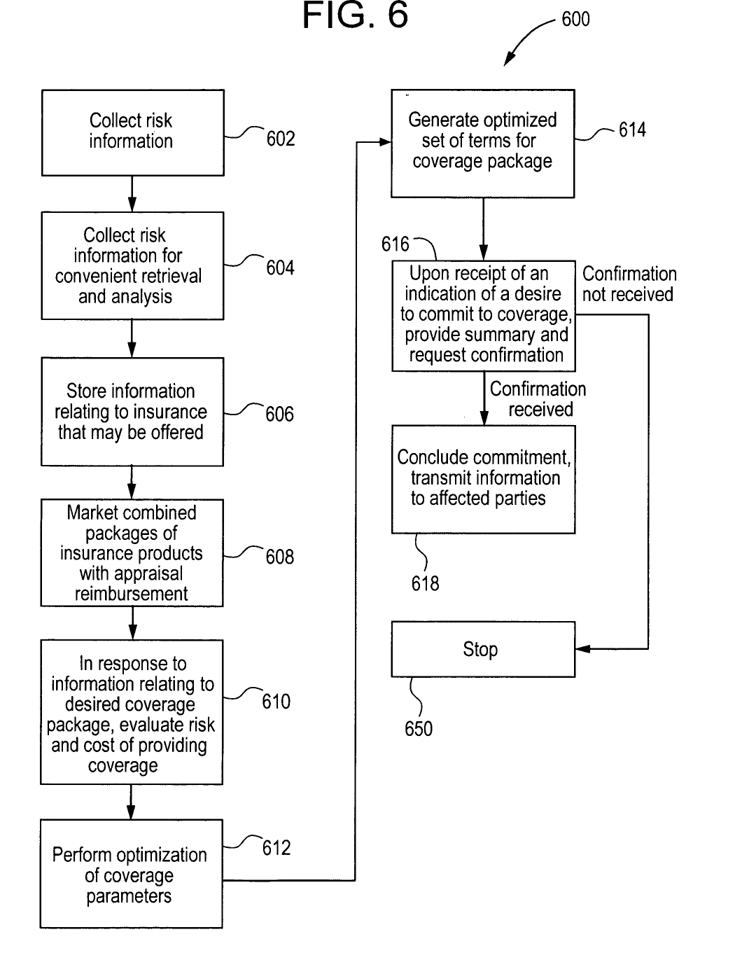

FIG. 6 illustrates a process 600 of insurance package evaluation, pricing and marketing according to an aspect of the present invention. The process 600 may be carried out using a system such as the system 100 of FIG. 1. At step 602, risk information is collected for use in evaluating risk to be insured. This information may take numerous forms, such as direct loss experience of an insurer, actuarial data, surveys, purchased economic data, or the like. The information may come from numerous different sources, such as data entry operators, subscription data services, harvesting of relevant information when insurance losses are paid, and as many other sources as are suitable and desired for use in assembling predictive data. At step 604, the risk information is assembled and stored for convenient retrieval. At step 606, information relating to various forms of insurance that may be used to create combined insurance packages is stored. The information may suitably include risks to be covered by each component, exclusions and limitations of each component, persons who qualify for coverage, or the like. Suitable components for which information is stored include mortgage insurance protecting a lender in the event of default on a mortgage, job loss insurance, providing for direct payment to a covered party or for payment or deferral of mortgage payments or other debts in the event of job loss, and borrower appraisal reimbursement. At step 608, marketing is performed relating to combined packages of insurance. One suitable form of package is a combined package of mortgage insurance and job loss insurance with appraisal reimbursement. The mortgage insurance component protects a lender in the event of default on a mortgage. The job loss component provides payment of monthly mortgage payments owed on a mortgage issued in connection with the package. Appraisal reimbursement allows the homeowner to seek an appraisal and cancel the mortgage insurance when the LTV has dropped as a result of home appreciation with the knowledge that the cost of the appraisal will be reimbursed up to a predetermined maximum.

Promotion may be accomplished by providing materials to lenders, through direct consumer promotion, through establishing websites providing promotional and educational information and by numerous other means. At step 610, in response to the presentation of information describing specific coverage needs for a package of coverage components, evaluation of the risk and cost of delivering each of the components is performed. Evaluation is accomplished by examining the coverage desired and using the stored risk data to compute the risks and cost of providing coverage on the terms desired. In addition, the risk and cost of the package as a whole is evaluated by taking into account the effect of each coverage component on the risks and costs involved in providing the other coverage components. At step 612, optimization of coverage parameters is performed. Adjustment of parameters of the coverage package are made and their effects on the risk and cost presented by the package as a whole are evaluated.

At step 614, an optimized set of terms for a coverage package is generated. At step 616, upon a receipt of an indication of a decision to commit to coverage on the terms described, a summary of the proposed coverage and terms is presented for confirmation. If an indication is received that a commitment to coverage is not desired, the process terminates at step 650. If an instruction to commit to coverage is received, the process proceeds to step 618 and a coverage commitment is concluded and suitable documentation is prepared and transmitted to responsible parties. The documentation may come in the form of paper documents to be signed and returned, in the form of electronic indications that coverage has been committed to, or any other suitable form sufficient to document the existence of an agreement. Coverage details are suitably stored in a database record associated with a consumer to be covered, a marketer of insurance packages on the terms that have been committed to, or any other party entering into the coverage package. Coverage details relating to each component of the package are provided to and may be stored in a database record associated with the provider of that component.

While the present invention is disclosed above in the context of aspects of an embodiment employing a specific system and exemplary web pages, and in the context of the specific combination of mortgage insurance with job loss protection and appraisal reimbursement, it will be recognized that a wide variety of implementations may be employed by persons of ordinary skill in the art consistent with the above discussion and the claims which follow below. By way of example, it will be recognized that mortgage insurance can be combined with other types of insurance or financial products to the extent that such combinations are deemed beneficial by consumers, and that the appraisal reimbursement feature of the present invention can be utilized in conjunction with a wide variety of mortgage insurance products and implemented with a wide variety of systems that are more or less automated.

FIG. 7 focuses on the aspects of appraisal reimbursement process showing an appraisal reimbursement process 700 in accordance with the present invention. The bulk of process 700 may be implemented using a suitably programmed computer based system, such as system 100. At step 702, a borrower submits an appraisal for a house to a loan servicer to support cancellation of the mortgage insurance. For mortgage insurance cancellation, all of the loan servicer's or mortgage investor's requirements for cancellation must be met regarding seasoning, LTV, evidence of value, payment status and the like. For example, a loan servicer or mortgage investor may require that the customer have at least a two year history of on time payments. After two years of on time payments, the LTV might be required to be 75% to allow cancellation of the mortgage insurance. As a further example, after five years of on time payments, a loan servicer might allow cancellation of the mortgage insurance with an LTV ratio of 80%.

In any case, once the loan servicer is satisfied that the requirements for canceling the mortgage insurance are met, the servicer notifies the mortgage insurer of cancellation. For example, the loan servicer may utilize an operator computer 122 to notify the mortgage insurer by email or by EDI. Typically, a loan servicer will internally process and code the cancellation request. A first code, such as MISMO code 1, might indicate that mortgage insurance should be canceled as a result of payoff of the loan. A second code, such as MISMO code 2, might indicate that the reason for cancellation is “LTV drop”. A third code, such as MISMO code 5, might indicate some other reason. The notification typically includes the date to cancel, reason to cancel, the mortgage insurance certificate number, the loan number, and where to send any applicable premium refund, typically the borrower. As noted above, LTV can drop as a result of a combination of factors. At present, loan servicers do not typically notify the mortgage insurer that the LTV drop was as the result of home appreciation established through a customer obtained appraisal.

Consequently, in step 706, since LTV can drop as a result of a number of factors not involving a borrower obtained appraisal, the mortgage insurer generates and sends an automatically generated reminder letter to the borrower reminding the borrower of the appraisal reimbursement feature. Where MISMO codes are utilized, a suitably programmed operator computer 122 may receive that code and determine where the MISMO code is 2 or 5 that appraisal reimbursement may be appropriate. In that case, the reminder letter may be automatically generated and printed using printer 123. An exemplary letter 800 is shown in FIG. 8 and discussed further below.

In step 708, where the LTV drop was a result of a borrower obtained appraisal, the borrower submits a completed refund application and supporting documentation to the mortgage insurer. For example, a mortgage insurer may typically require proof of appraisal payment, such as a canceled check, a credit card receipt, or the submission of a copy of a paid invoice for the appraisal, along with the completed refund application. The completed application would typically include the borrower's name and address, and the appraiser's name and address, but could include additional information as desired or required by the mortgage insurer.

Finally, in step 710, the mortgage insurer receives the borrower's submission, validates it, and issues a refund check. The refund check is based upon the actual cost of the appraisal up to some predetermined limit, such as $500, for example.

Turning to FIG. 8, this figure shows an exemplary automatically generated letter 800 which may be suitably employed in step 706 of FIG. 7 to remind borrowers, whose mortgage insurance is being cancelled due to LTV drop, of the appraisal reimbursement feature of their mortgage insurance. The letter has an upper portion 810 and a lower portion 820, and this letter may be automatically computer generated by a computer, such as operator computer 122 of FIG. 1, and printed with the printer 123. The lower portion 820 of letter 800 may be detachable and filled in by the borrower as the application for appraisal reimbursement. Alternatively, where a borrower elects to be notified by email and provides an email address, the letter 800 may be a Word™ document attached to an email sent to the borrower's computer, such as consumer computer 124, utilizing the Internet 114. Further alternatives are to forward a web browser form to the borrower, or to have the borrower access such a form using a consumer computer, such as computer 124.

The top portion 810 of letter 800 provides the borrower reminder, as well as, instructions or seeking reimbursement where applicable. The bottom portion 820 of letter 800 provides a detachable appraisal reimbursement application form which is preferably pre-populated with the mortgage insurance certificate number in a field 825, as well as other pre-populated information to speed processing by the mortgage insurer and reduce the work of the borrower. Because a copy of a receipt or invoice for the appraisal is to be submitted in this exemplary embodiment, it is preferred that the appraisal reimbursement request form be mailed or faxed with that supporting document to the mortgage insurer.

However, it will be recognized that the letter 800 of FIG. 8 could also be replaced with an emailed form to be displayed on a borrower's home computer, and this electronic form could be responded to electronically by filling in the form and attaching a scanned receipt or some other suitably reliable indicia of the cost and payment of the appraisal. The form and proof of payment could then be emailed back to the mortgage insurer. As one example, the mortgage insurer could have a relationship with the loan servicer, whereby the loan servicer would vouch for the cost of the appraisal as part of its determination that the cancellation requirements had been met, and then provide the borrower with a payment code which could be emailed by the customer to the mortgage insurer. The code could indicate both the identity of a trusted and reliable appraiser, as well as the amount paid. As a further alternative, the loan servicer could directly notify the mortgage insurer of the appraisal cost as part of or in addition to its notification of cancellation due to LTV drop in step 704. In this event, the process 700 would skip directly to step 710 and the mortgage insurer would issue a refund check.

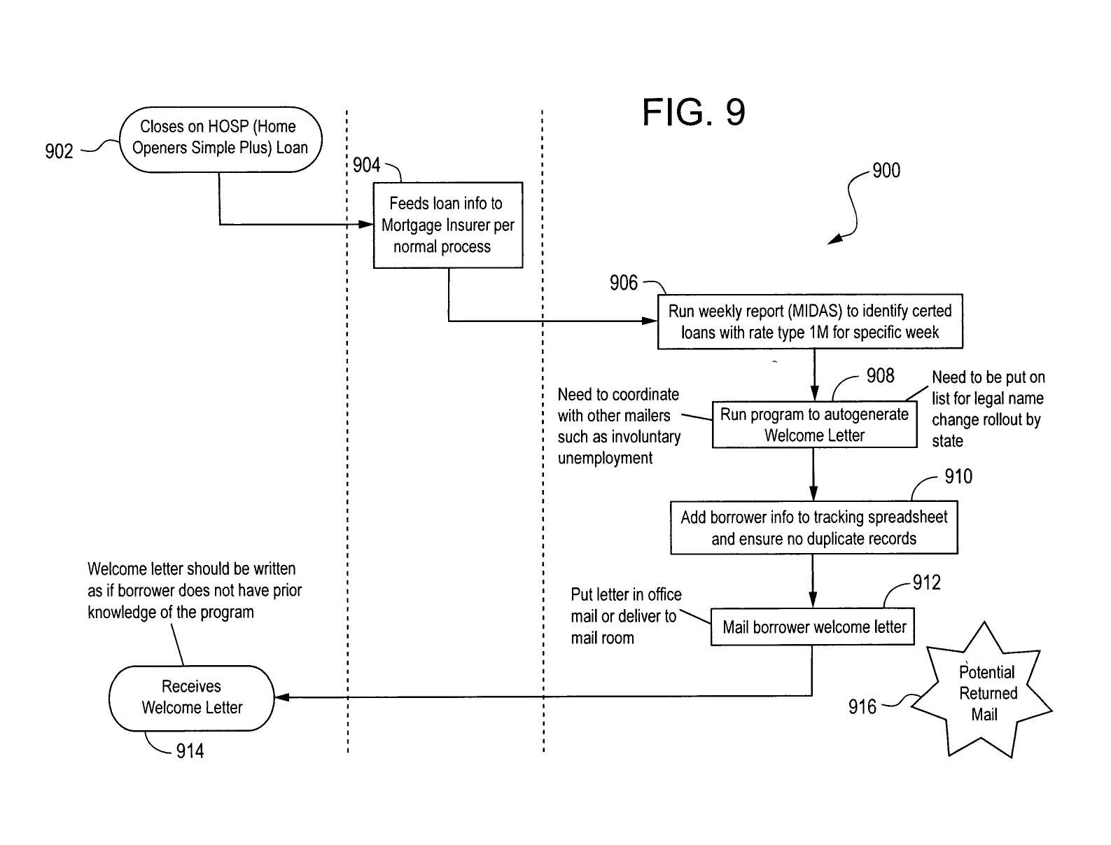

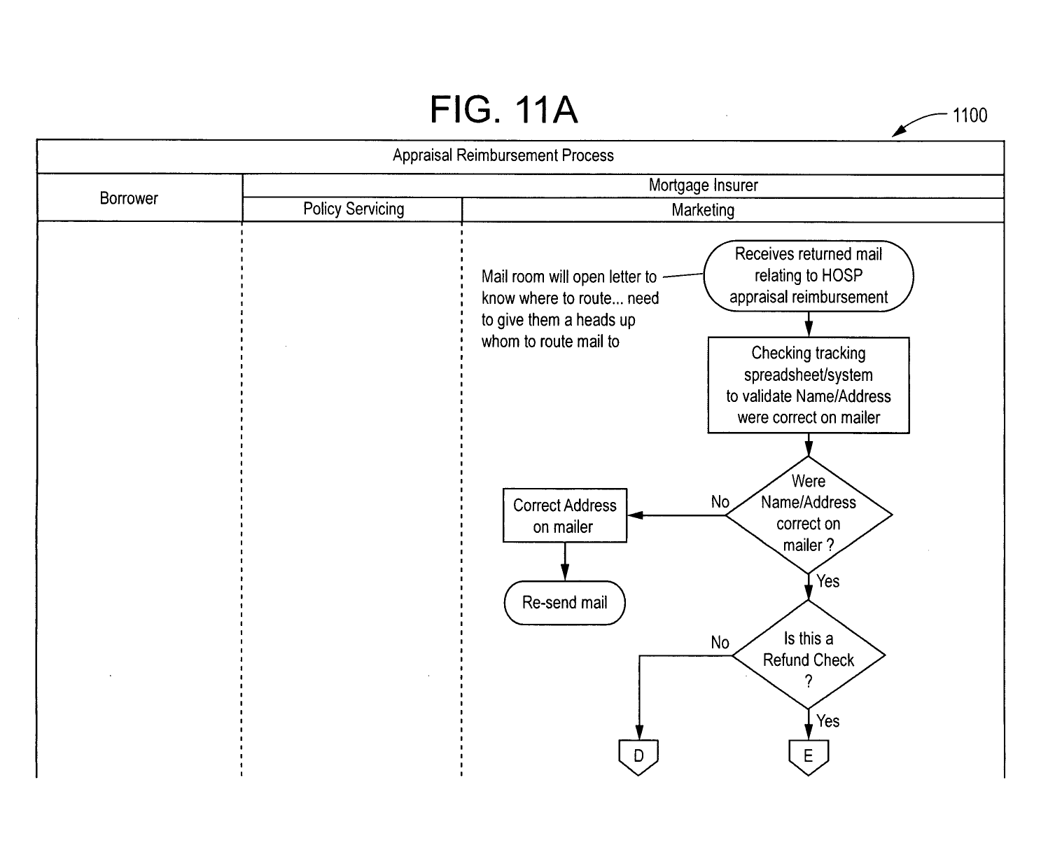

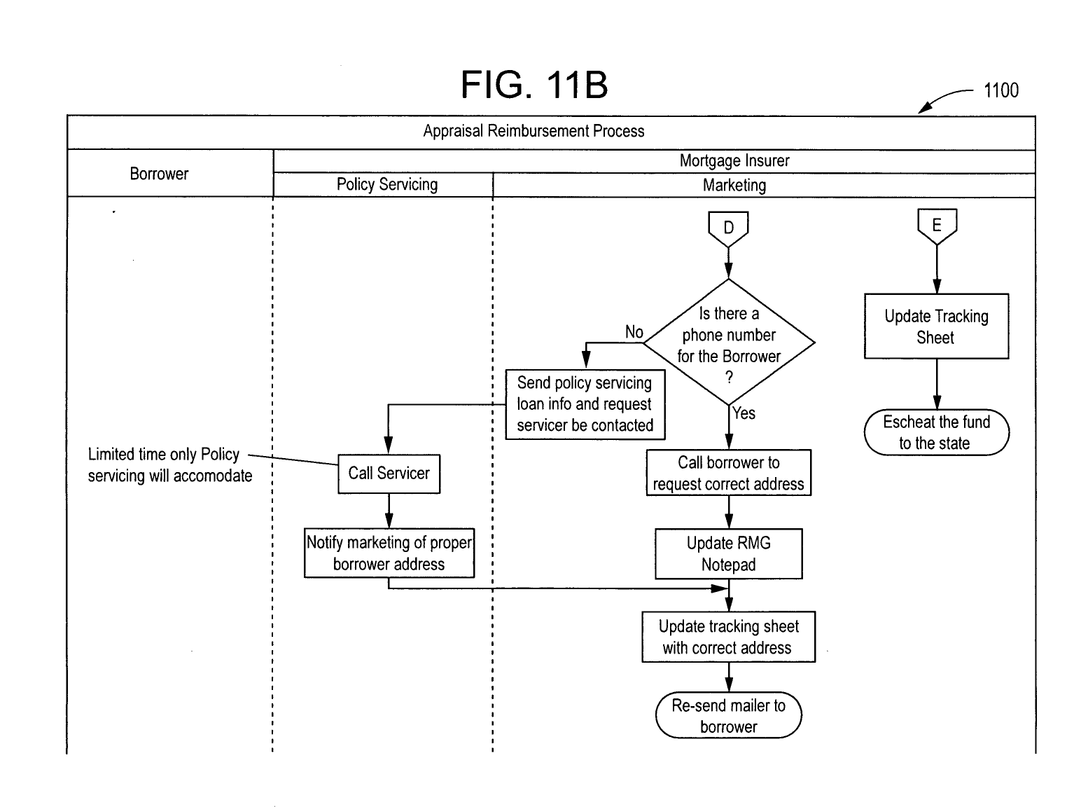

Turning to FIGS. 9-11, FIG. 9 shows an exemplary process 900 for automatically generating an appraisal reimbursement welcome letter. Process 900 may be implemented using any suitably programmed computer system, such as operator computer 122, for example. In step 902, a borrower closes on a loan including mortgage insurance and the loan servicer enters the pertinent data in its systems. In step 904, the loan servicer forwards loan information to a mortgage insurer. In steps 906, 908, 910, and 912, the loan information is processed, a welcome letter is automatically generated, and mailed to the borrower. In step 914, the borrower receives the welcome letter. In an alternative step 916, provision is made for the potential for returned mail. For example, where mail is returned with a forwarding address, the mail may be resent. If returned without a forwarding address, the mortgage insurer can follow-up with the loan servicer to obtain an up-to-date address, and update its records accordingly. Further details of one suitable process 1100 are shown in FIG. 11.

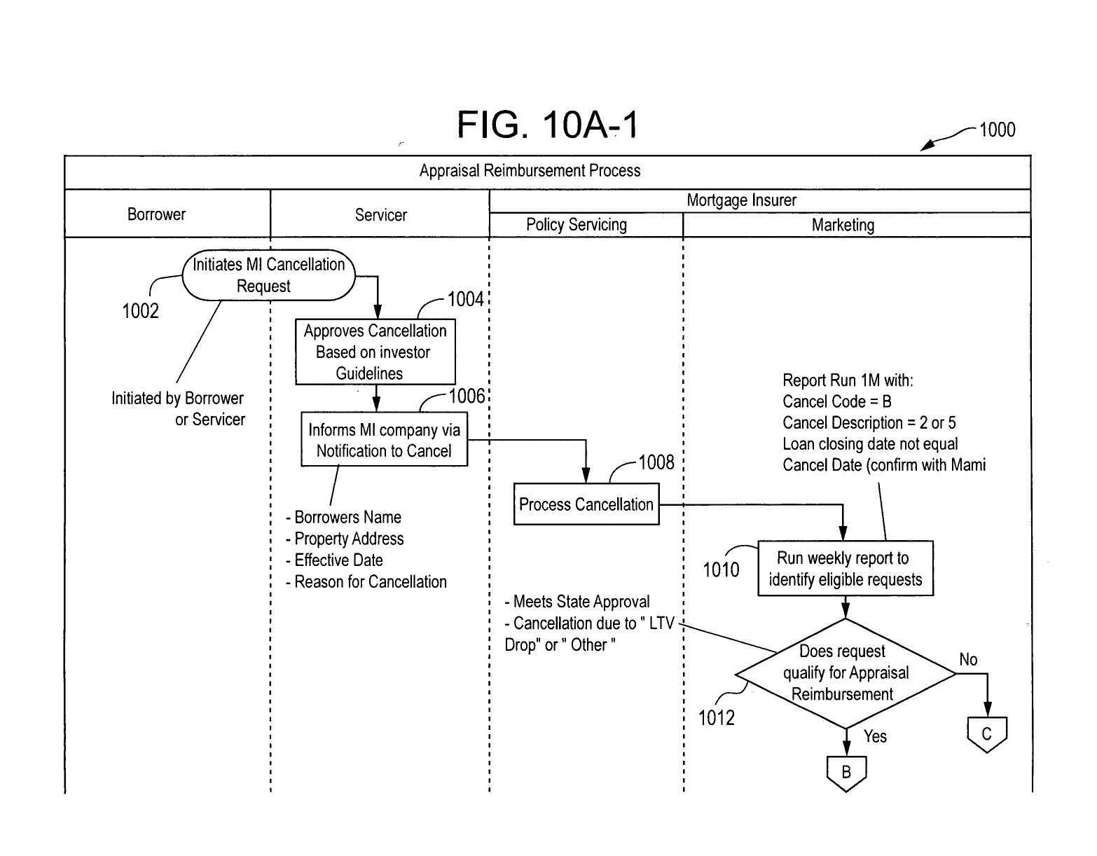

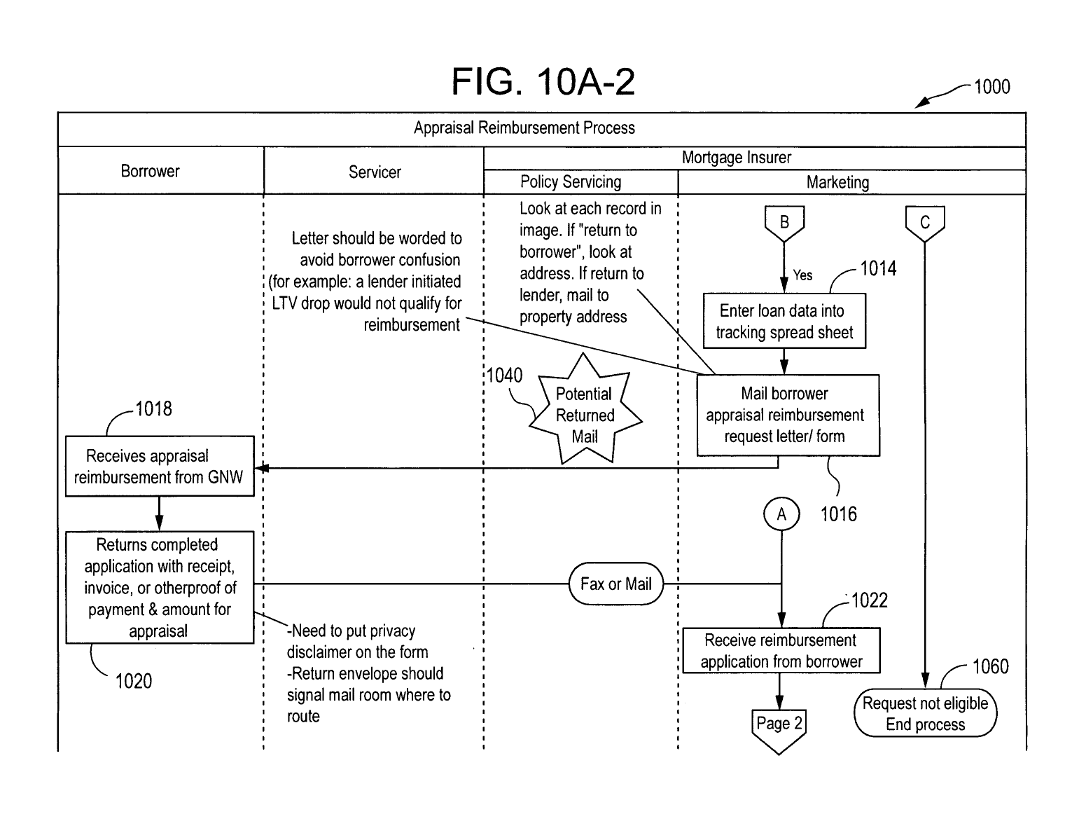

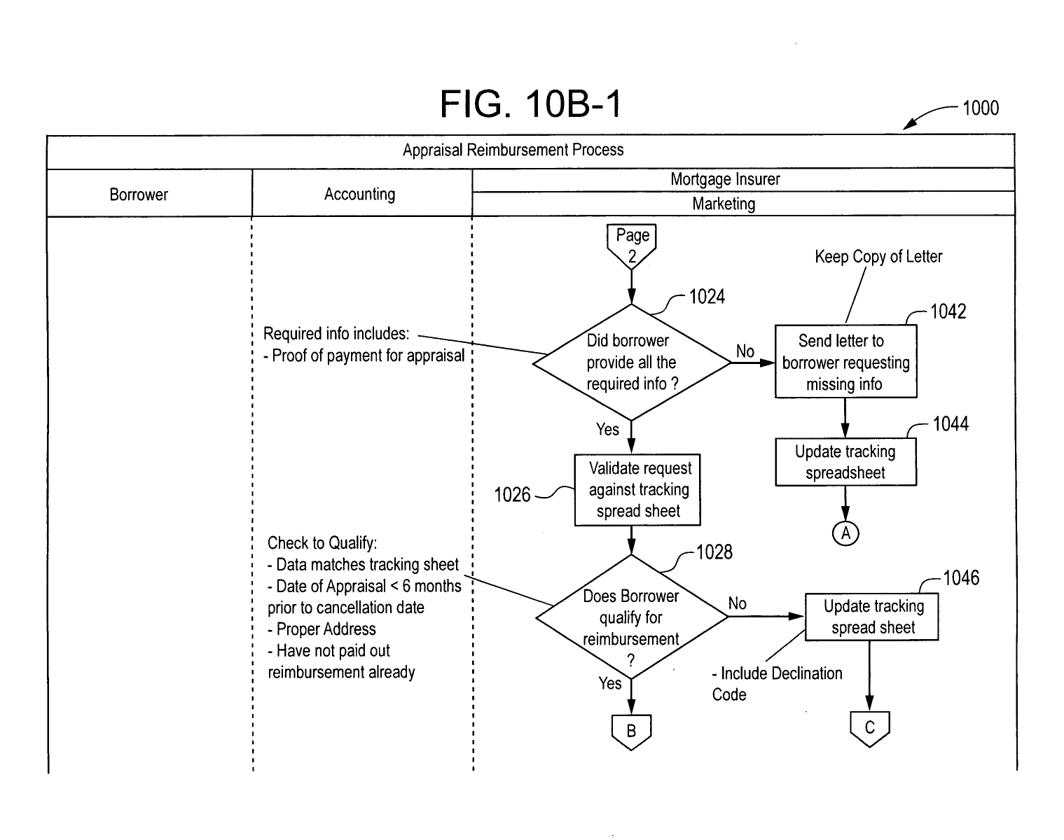

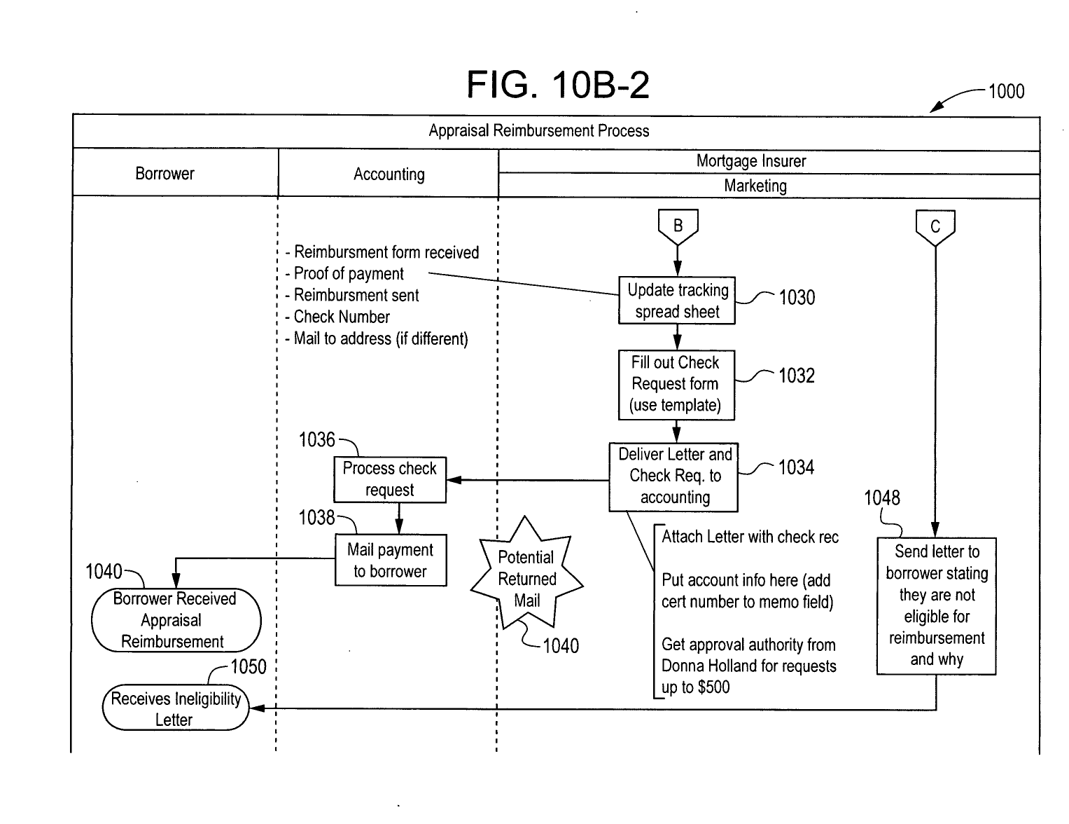

FIGS. 10A and 10B show details of a process 1000 for appraisal reimbursement. In step 1002, a mortgage insurance cancellation request is initiated by a borrower or loan servicer. In step 1004, the loan servicer approves cancellation based on investor guidelines. In step 1006, if the criteria for cancellation have been satisfied, the loan servicer informs the mortgage insurer of the cancellation. At step 1008, the mortgage insurer processes the cancellation. In step 1010, weekly reports are run to identify eligible requests. In step 1012, it is determined that the request qualifies for appraisal reimbursement. In step 1014, loan data is entered into a tracking spreadsheet. In step 1016, a borrower is mailed an appraisal reimbursement request form. In step 1018, the borrower receives the appraisal reimbursement request form. In step 1020, the form is completed and faxed or mailed with proof of payment. Finally, at step 1022, the mortgage insurer receives the application from the borrower. It is noted that, if at step 1012, it was determined that the request did not qualify for appraisal reimbursement, then process 1000 would proceed directly to step 1060 and end.

From step 1022, the process continues to step 1024 of FIG. 10B where it is determined if the borrower provided all the required information for reimbursement. If yes, in step 1026, the request is validated against the spreadsheet generated in step 1014. In step 1028, it is determined whether the borrower qualifies for reimbursement. At step 1030, the tracking spreadsheet is filled out. In step 1032, a check request is filled out. In step 1034, the check request is received and in step 1036, that request is processed. The check is then mailed to the borrower in step 1038 and received in step 1040. In both FIGS. 10A and 10B, the potential for returned mail is addressed in an optional step 1040 similar to step 916 of FIG. 9.

If at step 1024 it was determined that the borrower did not provide all the required information, then in step 1042, a follow-up letter is sent. In step 1044, the tracking spreadsheet is updated to indicate that the follow-up letter was sent.

If at step 1028 it was determined that the borrower did not qualify for reimbursement, then the spreadsheet is updated in step 1046. For example, a drop in LTV might be as a result of a lump sun payment by the borrower and the appraisal might be obtained in connection with the borrower putting the home on the market. In step 1048, a letter is sent to the borrower stating that he or she is not eligible for reimbursement and explaining why that is the case. In step 1050, the borrower receives the ineligibility letter.

Finally, FIG. 11 illustrates a process 1100 of handling returned mail.

While the present invention is described above in a variety of contexts, it will be recognized that the systems and processes can be more or less automated with a suitably programmed computer automatically updating a tracking spreadsheet in response to appropriate inputs from an operator, in response to scanning a piece of returned mail, or receipt of electronic notifications from loan servicers or borrowers, or the like.

We claim:

1. A method for providing customer reimbursement for an appraisal obtained by a borrower to cancel mortgage insurance, comprising the steps of:
receiving notification from a loan servicer that the loan servicer's requirements for canceling a mortgage insurance policy have been met as a result of a loan to value ratio drop; and
automatically notifying the borrower covered by the mortgage insurance policy that reimbursement is available if an appraisal was obtained to cancel the mortgage insurance.

2. The method of claim 1 further comprising the step of receiving verification of entitlement to reimbursement from the borrower.

3. The method of claim 2 wherein the verification of entitlement comprises proof of the cost of the appraisal.

4. The method of claim 3 wherein the proof of the cost of the appraisal comprises a credit card receipt, a canceled check, or a copy of a paid invoice.

5. The method of claim 2 further comprising the step of reimbursing the borrower for the cost of the appraisal up to a predetermined limit.

6. The method of claim 5 wherein the predetermined limit is established on a region by region basis to reflect actual appraisal costs by region.

7. The method of claim 5 further comprising the steps of:
storing the predetermined limit established on a region by region basis in memory; and
electronically retrieving from memory the predetermined limit for the region in which the appraisal was performed.

8. The method of claim 1 wherein the step of automatically notifying the borrower further comprises printing a letter to the borrower, said letter including an appraisal reimbursement application form pre-populated with information identifying the borrower and the mortgage loan.

9. The method of claim 1 wherein the step of receiving notification from the loan servicer further comprises electronically receiving a mortgage insurance certificate number, information indicating that said mortgage insurance certificate should be canceled, and a coded indicia indicating the reason for cancellation is the loan to value ratio drop.

10. The method of claim 1 wherein the step of receiving notification from the loan services further comprises the step of electronically receiving a MISMO code indicating the reason for mortgage insurance cancellation, recognizing the MISMO code with a programmed computer, and automatically generating a borrower notification letter by the programmed computer.

11. A system for reimbursing a customer for an appraisal obtained to cancel mortgage insurance, the system comprising:
means for receiving notification from a loan servicer that the loan servicer's requirements for canceling a mortgage insurance policy have been met as a result of a loan to value ratio drop; and
means for automatically notifying the borrower covered by the mortgage insurance policy that reimbursement is available if an appraisal was obtained to cancel the mortgage insurance.

12. The system of claim 11 comprising means for receiving verification of entitlement to reimbursement from the borrower.

13. The system of claim 12 wherein the means for receiving verification of entitlement to reimbursement from the borrower comprises means for receiving data establishing the cost of the appraisal.

14. The system of claim 13 wherein said data establishing the cost of the appraisal is credit card receipt data, canceled check data, data from a copy of a paid invoice.

15. The system of claim 12 comprising means for reimbursing the borrower for the cost of the appraisal up to a predetermined limit.

16. The system of claim 15 wherein the predetermined limit is established on a region by region basis to reflect actual appraisal costs by region.

17. The system of claim 16 further comprising:
a memory storing the predetermined limit established on a region by region basis; and
means for electronically retrieving from the memory the predetermined limit for the region in which the appraisal was performed.

18. The system of claim 11 further comprising a printer for printing a letter to the borrower, the letter including an appraisal reimbursement application form; and
means for pre-populating the letter with information identifying the borrower and the mortgage loan.

19. The system of claim 11 further comprising means for electronically receiving a mortgage insurance certificate number, information indicating that said mortgage insurance certificate should be canceled, and a code indicating the reason for cancellation is loan to value ratio drop.

20. The system of claim 11 further comprising means for electronically receiving a MISMO code indicating the reason for mortgage insurance cancellation, automatically recognizing the MISMO, and automatically generating a borrower notification letter.
